(19) United States
(12) Patent Application Publication
(10) Pub. No.: US 2007/0250211 A1
(43) Pub. Date: Oct. 25, 2007

(54) Method for Automatically Analyzing Transport Courses

(75) Inventors: Bernhard Berlin, Berlin (DE); Helmut Langhammer, Berlin (DE); Rolf Kupfernagel, Berlin (DE); Holger Paetsch, Zernsdorf (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens Aktiengelsellschaft, Munich (DE)

(21) Appl. No.: 11/632,869

(22) PCT Filed: Jul. 26, 2005
(86) PCT No.: PCT/EP05/08115

§ 371 Date: Jan. 19, 2007

(30) Foreign Application Priority Data
Jul. 26, 2004 (DE) 10 2004 036 250.5

(51) Int. Cl. G06F 17/00

(52) U.S. Cl. 700/244

(57) ABSTRACT

In a network using quality test letters (QTL), transport courses are automatically analyzed and physical characteristics are recorded over time during the transport and subsequently read out and classified. The method identifies each QTL message in a node, and determines spatiotemporal relations with respect to nodes passed through. The logistical process chain passed through by each message is automatically determined with process elements from the spatiotemporal relations. All possible required transport courses of each QTL message sent are automatically generated, starting from a respective point of network entry and point of network exit, with associated times as well as selected transport conditions from defined transport rules between the nodes of the logistics network and from a description of execution sequences in the nodes and the relationships between the nodes. A comparison is performed between all required transport courses and an actual transport course of each transported QTL message, and differences are determined. The differences are recorded.

The invention relates to a method for automatically analyzing transport courses in accordance with the preamble of claim 1.

Weak points in logistical networks, such as sorting and postal services frequently lead to delayed delivery when transporting items for delivery. Often the operators of logistical networks, such as postal services, are well aware of the existence of such weak points, but find it very expensive, or even impossible to locate them with conventional means.

Systems are known for monitoring goods, such as that described in DE 3 942 009 A1 which aims to monitor transport units, (by incorporating devices into the frame construction of containers for example). Monitoring of any given delivery item is not possible Nor are these systems able to determine automatically and independently the type and timing of the transport processes, with which a specific delivery item is transported. Furthermore there are transponder-based (e.g. with transponders in accordance with DE 69609765 T) methods, which make it possible to establish when a delivery item has passed through a specific sorting center (U.S. Pat. No. 3,750,167 A1).

A further possibility for establishing when a delivery item has passed through a specific sorting center is described in CA 2285894.

These systems can however only establish whether a delivery item was transported in time or not. No conclusions can be drawn however about the causes of a late delivery. Since there is no evidence about the progress of the transport chain, it is also not possible for example to prove who might be responsible for any delays occurring.

Currently postal services employ the quality test letter (QTL) for localizing weak points (EP 0 744 030 B1, DE 196 19 068 A1). This QTL and the associated software for visualizing the measured values allow the transport processes and their timing to be uniquely determined. However with this system it is not possible to establish a spatial reference.

The object of the invention is to create a method for automatically analyzing transport courses in logistics networks, with which weak points in logistics chains can also be determined automatically.

In accordance with the invention the object is achieved by the features of claim 1.

The following inventive steps are executed:
Identification of each QTL message in the node, determining the spatiotemporal relations of the nodes passed through,
Automatically determining the logistical process chain passed through by each message with the process elements from the spatiotemporal relations and the recorded physical states such as emptying mailbox, transport types, sorting/processing, delivery, . . . ) over time by means of an expert system.

Advantageous embodiments of the invention are set down in the subclaims.

It is thus advantageous to perform the following additional steps:
Automatic generation of all possible required transport courses of each QTL message sent, starting from the respective point of entry and point of exit into or from the logistics network with the associated times as well as the selected transport conditions from defined transport rules between the node of the logistics network and from the description of the execution sequences in the node and the relationships between the nodes,
Comparison between the required transport courses and the actual transport course of each transported QTL message and determination of the differences,
Recording the difference between the actual transport course and the required transport course, and determining the required transport course with the best match for each transported QTL message in a weak point database.

It is also advantageous to analyze the differences recorded in the weak point database for weak point analysis.

To reduce the effort involved in generating the required transport courses it is advantageous for the logistics network to be subdivided into network planes and part networks for which the transport rules between the nodes and the description of the execution sequences in the nodes and the relationships between the various nodes are defined respectively.

To obtain a more detailed analysis of the differences it is advantageous to evaluate the differences with regard the subprocess identified and/or the type of difference and/or the cause of the difference.

There are a number of advantageous options for identifying the QTL messages.

The QTL messages can thus be provided with machine-readable identifiers.

In a further option at least one QTL message identification and a test course identification are incorporated into 2D bar codes for franking.

The QTL messages can also be provided with transponders which are then read out in the node and stored with a time reference.

It is also possible for the QTL messages to use a receiver to detect that they have passed a node on the basis of a stationary identification sent by radio and to store this information with a time reference in the QTL message.

The QTL messages can be identified without any additional features by determining characteristic features from their surface with the address details and storing these together with the destination addresses as well as the further test data in a database. In the required nodes the characteristic features of the letter surfaces with the address details of the incoming letters are likewise determined and stored in the database. The relevant QTL message is determined by means of comparing the features detected in the node with the features assigned to the QTL message, with the QTL message being identified to the defined extent if they match.

In a further advantageous variant of this process, in which, for improved handling of the great flood of data, a decentralized method of operation has been chosen, characteristic features are determined from their surface before the entry of the QTL messages into the logistics network and stored together with the destination address as well as the further test data in a central database. The data for these features and the further test data are transmitted to the required node, where the relevant QTL message is determined by comparing the transmitted features with the detected features, and if they match to the defined extent, the QTL message is identified

The invention will be explained below with reference to the drawings in an exemplary embodiment.

The figures show:

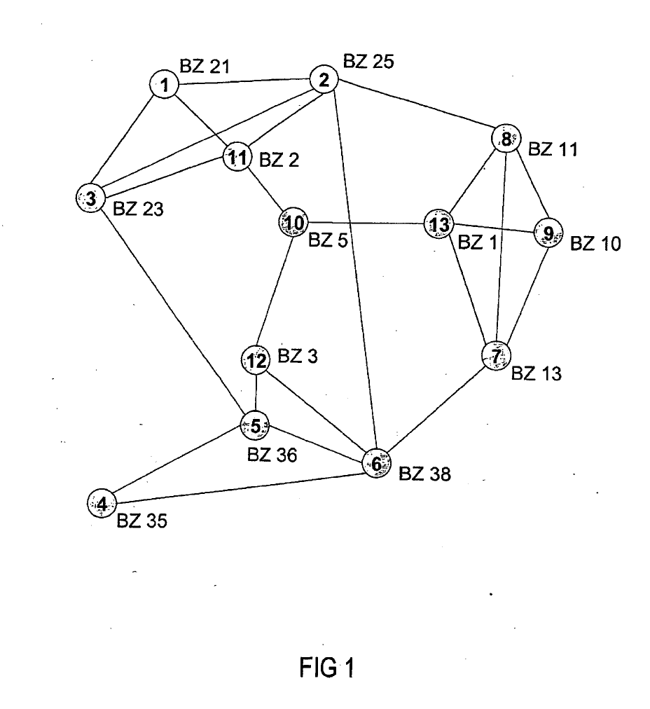

FIG. 1 a schematic diagram of a combined road and air postal network (overall network),

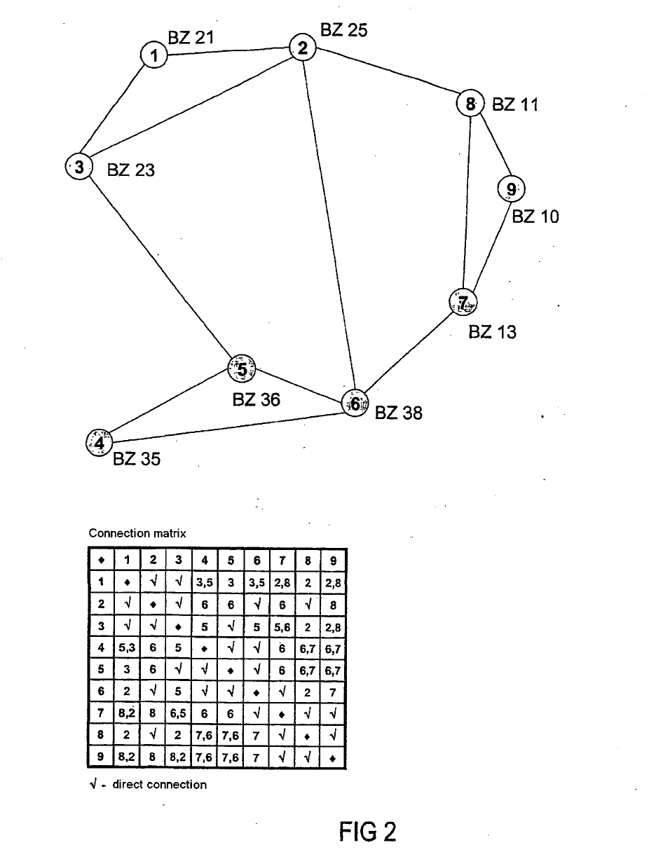

FIG. 2 the network plane of the long-distance road transport,

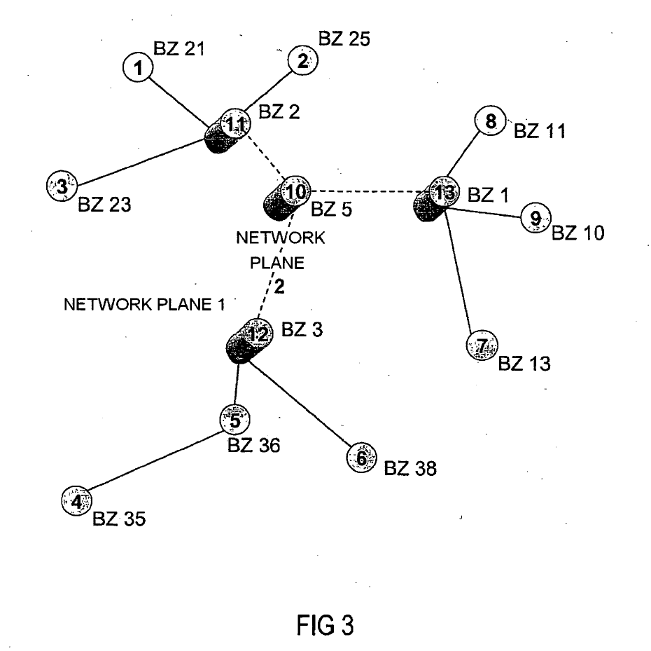

FIG. 3 the airmail network plane with two part network planes,

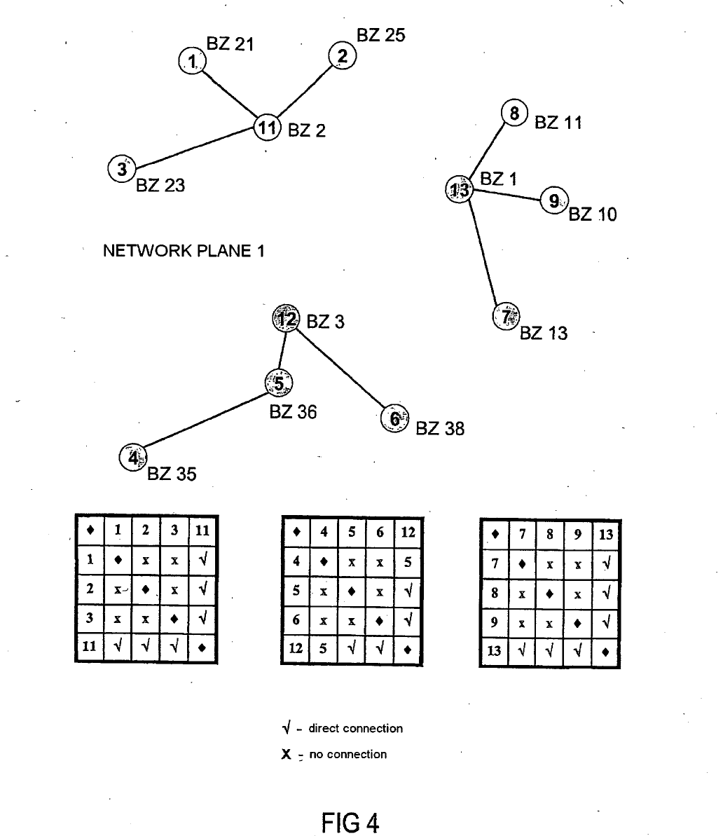

FIG. 4 the part network plane 1 as feeder network to airports with connection matrix,

FIG. 5 the part network plane 2 as air mail network with connection matrix,

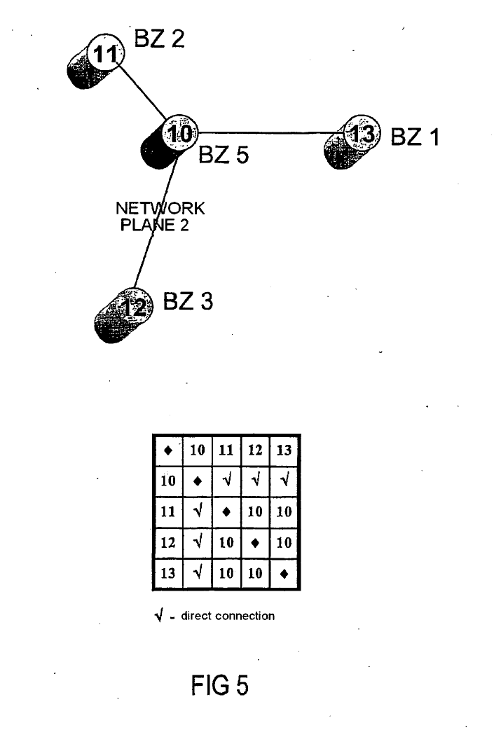

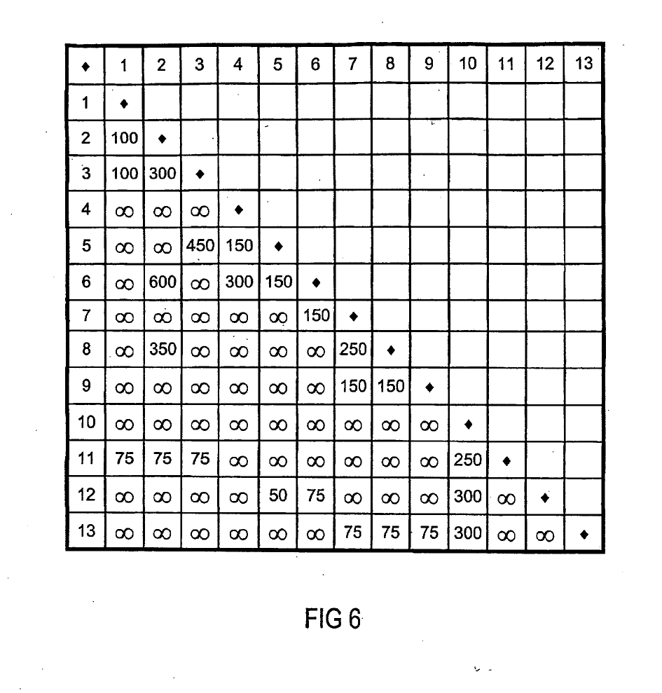

FIG. 6 a distance matrix for the overall network,

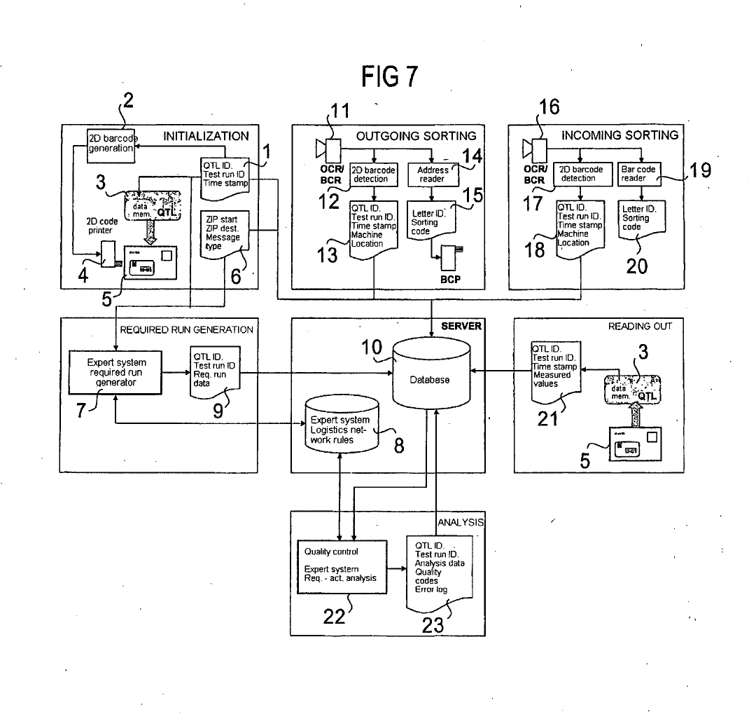

FIG. 7 a structure description of the analysis method with modified 2D bar codes for identification of the QTL messages in sorting machines of the relevant nodes,

FIG. 8 a structure description of the analysis method with RFID technology for identification of the QTL messages in sorting machines of the relevant nodes,

FIG. 9 a structure description of the analysis method with identification of the QTL messages on the basis of characteristic features of the message images.

The possible required transport course or courses for the message is or are generated with the aid of an expert system based on details of the outgoing and incoming location and on predefined rules for logistics, and assigned in a database to the relevant test run data.

To generate the required transport course the logistics network is subdivided into different logical network planes and part networks.

For the network planes concerned generally-applicable rules are defined for transport between the nodes depending on the individual service levels, as well as the interrelationships between the individual nodes.

A logistical network consisting of a combined road and air postal network will be considered here as an example. In which case the transport between the network nodes or processing centers (BZ) can be undertaken using different methods. Such a network is shown in FIG. 1. To generate the required run the logistical network is divided up into different logical network planes and part networks. It is thus assumed in the case used as an example here that the overall network is made up of a road and an air postal network.

These can also be seen as logical network planes (see FIG. 2 and FIG. 3)

FIG. 2 shows the logical network planes for the long-distance road transport. The connection matrix defines the method by which transport usually occurs between the nodes. Thus in the example the transport connection between nodes 4 and 1 is defined as a route via nodes 5 and 3. Transport via other nodes would in our example thus be a misdirection of the goods to be transported.

The airmail network for example can logically be divided into two planes.

Firstly into a plane which describes the feeder transport to the airport (see FIG. 4) and secondly into a network which describes the relationships between the airmail nodes (FIG. 5)

The definitions of the relationships between the network nodes are again implemented by a connection matrix.

A distance matrix is also to be created for the network nodes in order to enable the predicted durations of the individual transport processes to be derived from this.

The distance values for non-implemented (impermissible) connections are set to a value of infinite or zero. With the aid of the definition of an average transport speed for individual network planes or part networks, the average duration of the relevant transport processes between the nodes can then be determined. (t=s/v)

The outgoing node and the incoming node can be determined for example using the zip code of the location where the item was posted and of the destination location, by assigning specific ranges of zip codes to a corresponding node.

If outgoing nodes of the relevant incoming nodes are determined, the expert system can determine all possible variants of transport between these nodes. In this case a search is conducted iteratively through all network planes for possible transport sequences. For the logistics network described here, for dispatch from node 1 to node 6 the following alternatives would thus be produced when passing through the nodes:

1. 1,3,5,6 (road transport network plane)

2. 1,11,10,12,6 (air transport network plane)

For dispatch in the reverse order the following sequence would be produced:

3. 6,2,1 (road transport network plane)

4. 6,12,10,11,1 (air transport network plane).

Thus it is both possible to use road transport alone and to use both road and air transport.

In the next step the possible required runs can be generated by expert systems using the sequence of nodes passed through and with the aid of the rules.

The typical starting point here is a post-logistical system.

The number of required runs generated depends on the scope of the rule system. However the aim of the method is to produce a high degree of abstraction in the description of the logistical sequences in order to keep the effort involved in entering and modifying the system to a minimum.

To illustrate this, the corresponding required runs are to be generated for the typical logistics network using the following rules.

1. Rules for processing

Processing only occurs in the outgoing and incoming node
Average duration of transport to delivery base: 0.5 h
Average duration of processing in the outgoing node: 3.0 h
Average duration of processing in the incoming node: 2.0 h
Maximum transshipment time in nodes passed through: 0.5 h
Outgoing processing Monday-Friday
   Latest end time of processing in the outgoing node: 22:30
Processing outgoing deliveries on Sundays
   Latest end time of processing in the outgoing node: 19:30
Processing input Monday-Saturday
   Latest end of processing in the incoming node: 06:30
   2. Rules for inwards delivery
Average duration of box emptying: 2 h
Mailbox emptying times:
   Monday-Friday: 16:00-18:00
   Saturday, Sunday: 12:00-14:00
End times for mailbox emptying (delivery to the incoming node):
   Monday-Friday: 19:30
   Saturday, Sunday: 16:00
   3. Rules for delivery
Earliest start of delivery: 07:30
Latest end of delivery: 12:00
Average duration of delivery: 3.0 h
   4. Rules for air transport network plane
Time window for the flights: 24:00-03:00
Transport days: Monday-Friday
average transport speed of flight: 300 km/h
average transport speed of truck: 60 km/h
maximum length of transshipment at node 10: 0.5 h
   5. Rules for road transport network plane
average transport speed: 90 km/h
maximum duration of transshipment in nodes: 0.5 h
   6. Rules for delivery time
   (only required for required-actual comparison and error analysis)
Delivery time target depending on form of postal item:
Urgent delivery=E+1; 1st class=E+2; 2nd class=E+3
Delivery time target depending on the time of day of inwards delivery: for all postal items posted after 16:00 the delivery time increases by one day
Delivery time target depending on day of the week on which item was posted
   Posted on Saturday then counts as delivered on Sunday
Delivery time target depending on the time of day of posting: for all postal items posted after 18:00 the delivery time increases by one day

For the logistics network described here, the following required runs are to be determined for dispatch from node 1 to node 6, taking into account the rules defined above:

Firstly the duration and the type of transport (in hours) between the nodes is determined.

Transport Variant 1:

Node 1, 3, 5, 6 (Road transport network plane)

| | | | | Type of | |
|---|---|---|---|---|---|
| Relation | Speed | Distance | Duration | transport | Network plane |
| 1-3 | 90 km/h | 100 km | 1.1 h | Truck | Road transport |
| 3-5 | 90 km/h | 450 km | 5.0 h | Truck | Road transport |
| 5-6 | 90 km/h | 150 km | 1.6 h | Truck | Road transport |

Transport Variant 2:

Node 1, 11, 10, 12, 6 (air transport network plane)

| | | | | Type of | |
|---|---|---|---|---|---|
| Relation | Speed | Distance | Duration | transport | Network plane |
| 1-11 | 60 km/h | 75 km | 1.3 h | Truck | Air transport |
| 11-10 | 300 km/h | 250 km | 0.8 h | Flight | Air transport |
| 10-12 | 300 km/h | 300 km | 1.0 h | Flight | Air transport |
| 12-6 | 60 km/h | 75 km | 1.3 h | Truck | Air transport |

This would produce the following required runs depending on the time of initial delivery:
1. Posted Monday-Friday before 16.00

Required Run for Transport Variant 1:

| | |
|---|---|
| Box emptying | (earliest) Start 16:00, |
| | (latest) end 18:00 |
| Processing node 1 | (earliest) Start 18:00, |
| outgoing node) | (latest) End 22:30 |
| Road transport | Start 22:30, End 23:40 (rounded) |
| Transshipment at node 3 | Start 23:40, End 00:10 (next day) |
| Road transport | Start 00:10, End 05:10 |
| Transshipment at node 5 | Start 05:10, End 05:40 |
| Road transport | Start 05:40, End 07:20 |
| Processing at node 6 | Start 04:30, End 06:30 (next day) |
| (ingress node) | |
| Road transport | Start 06:30, End 07:00 |
| (delivery basis) | |
| Delivery | (earliest) Start 07:30, |
| | (latest) End 12:00 |

Road transport to node 6 ends by around 07:20. In this way sorting in accordance with delivery bases and on-time transport to the delivery bases can no longer take place the same day.
Duration: E+2

Required Run for Transport Variant 2:

| | |
|---|---|
| Box emptying | (earliest) Start 16:00, |
| | (latest) End 18:00 |
| Processing at node 1 | (earliest) Start 18:00, |
| Egress node) | (latest) End 22:30 |
| Road transport | Start 22:30, End 23:45 |
| Transshipment at node 11 | Start 23:45, End 00:15 (next day) |
| Flight | Start 00:15, End 01:05 16:00 |
| Transshipment at node 10 | Start 01:05, End 01:35 |
| Flight | Start 01:35, End 02:35 |
| Transshipment at node 12 | Start 02:35, End 03:05 |
| Road transport | Start 03:05, End 04:20 |
| Processing at node 6 | Start 04:20, |
| Ingress node) | (latest) End 06:30 |
| Road transport | Start 06:30, End 07:00 |
| (Delivery base) | |
| Delivery | (earliest) Start 07:30, |
| | latest) End 12:00 |
| Duration: E + 1 | |

2. Posted on Saturday before 12.00

Required Run for Transport Variant 1:

| | |
|---|---|
| Box emptying | (earliest) Start 12:00, |
| | (latest) End 16:00 |
| Processing at node 1 | (earliest) Start 16:00, |
| (Egress node) | (latest) End 19:30 |
| Road transport | Start 19:30, End 20:40 (rounded) |
| Transshipment at node 3 | Start 20:40, End 21:10 |
| Road transport | Start 21:10, End 02:10 |
| Transshipment at node 5 | Start 02:10, End 02:40 |
| Road transport | Start 02:40, End 04:20 |
| Processing at node 6 | Start 04:20, End 06:30 (next day) |
| (Ingress node) | |
| Road transport | Start 06:30, End 07:00 |
| (Delivery base) | |
| Delivery | (earliest) Start 07:30, |
| | (latest) End 12:00 |
| Duration: E + 1 | |

Required Run for Transport Variant 2:

Transport variant 2 is restricted to the traffic days Monday to Friday. The postal items mould therefore have to be stored in the ingress node and not taken away until Monday (as shown above).

Duration: E+2

The required runs illustrated here are only a subset of the required runs which can be generated with these rules. The expert system generates all theoretically possible required runs however which are generated on the basis of the rules.

Postal items with duration target E+2 can be transported as planned with a required run with duration E+1 as also with a required sequence with duration: E+2.

The check as to whether a run target was adhered to however is undertaken in the quality control expert system.

The required run generator expert system is able, because of this knowledge and a distance matrix of all nodes in the network, to determine all options, such as how a postal item can be transported from a point A to a point B and the associated timing requirements. The rules for delivery time give the requirements for the quality of the services provided and the rules for the logistics network describe the start and end time of the logical sequences.

This means that no image of a timetable is required for generating the required runs. This logical division of the network means that only slight modifications are required if transport courses are changed, since only the rules for specific network components have to be changed.

During the processing of the postal items in the individual sorting centers these items are recognized automatically and thus the local change registered and also automatically added into the existing test sequence data After the end of the test runs the data is read out of the QTL messages. The type and the precise time sequence of the transport processes based on measurement of the physical characteristics of different means of transport can be determined from this data.

In the next step the required transport courses created by the required run generator are compared with the associated actual transport courses. In this case all generated required runs are checked for their degree of compliance with the actual run and the required run with the highest level of compliance determined.

The differences between the required run and the actual run for this required run are determined precisely in a further expert system and the weak point in the logistical system determined.

The type of the error-prone process, the type of error and also the event which caused the error can be detected by the expert system.

Expert System Required-Actual Analysis

A tracking system is used to determine the node and the time that the QTL spends in the node. This gives the actual processing and transshipment times in the node. If no ongoing tracking is to be undertaken in the nodes, the average processing times must be used as a starting point, or the period between the transports before and after the scan in a node is defined as the processing time. The individual transport processes are obtained by the analysis module in the expert system required-actual analysis from the measured values of the QTL.

Because of the functional principle of the QTL (acceleration measurement) the measurement is very strongly position-dependent. Whether specific transport processes can be detected with a sufficient degree of certainty therefore depends on the position of the QTL within the means of transport.

This cannot be influenced however since the QTL is transported like a normal letter and can also not be differentiated from a normal letter.

From this and from the manner in which some letters are transported in postal services (e.g. in sacks), the measured values can be greatly attenuated and a secure detection of the transport process is not longer possible without further expert knowledge.

For energy efficiency reasons the QTL only measures in cycles. The resulting of this is that a transport process must last at least 10 minutes so that the physical characteristics are appropriately marked to enable a type of transport to be detected with a sufficiently high probability.

If the QTL measurement method is now combined with a tracking method, the expert system is given further information (location, time), which can be included for analysis of the measured values.

Firstly the measured values are analyzed without location information. Then the transport processes detected are assigned to the periods between their stays in the nodes. The route covered can be determined from the type and the duration of transport process with the inclusion of the rules for the logistics network.

Should this produce wide differences from the value defined in the distance matrix, the time is to be analyzed more precisely by the expert system.

If there is a deviation upwards it is to be assumed that there is an irregularity in the transport course (e.g. congestion). With a strong deviation downwards a transport process has not been detected. This can for example be caused by a strong attenuation of the measurement. If a QTL is transported for example in a sack with many letters and if it is additionally not in an optimum position, it can occur that transport phases with very slight accelerations (vibrations) can no longer be measured. This frequently occurs on flights in particular. The take-off and landing phase is still detected sufficiently because of the high intensities occurring, however a flight phase can no longer be determined. This results in a very low level of credibility for transport by air and this transport process is discarded by the expert system.

With the knowledge that a corresponding distance was not covered with the recognized transport process the expert system can now analyze the corresponding time segment. Transport processes which were rejected without the knowledge of the distance to be covered are given greater credibility in the second step. Another check is now made as to, whether the distance which was covered with the transport process matches the value in the distance matrix. If the distance covered is now far too great a misinterpretation is to be assumed and the result is to be rejected. Should the distance still be too small, not all transport processes have yet been detected.

In these cases further iterations must be performed with the assistance of general logistical ground rules (not the rules for the required run generation). Should the subsequent iterations not produce the desired result, the credibilities of the individual transport processes are to be checked.

The physical characteristics of the different types of transport are often very similar under some circumstances. This is the case for example with rail and road transport. Should both types of transport be possible in the logistical course, a check should be made by the expert system as to whether for example both road and rail transport were detected for the same period and the credibilities for the transport types lie very close to each other. Changing the type of transport also means as a rule that the distance covered changes. Subsequently the result should again be checked for plausibility.

Furthermore there are logistical processes which represent a sequence of very short individual transport processes. In a postal logistics network these are emptying the mailbox and delivering the mail.

The mailbox emptying is a sequence of short journeys by road.

Short transport phases are interrupted by the stops for emptying the mailboxes.

The delivery is mostly undertaken on foot or by bicycle and is characterized by short paths from house to house and rest phases when putting the postal items into the mailboxes.

Because of the brief duration of the individual events these are discarded by the expert system and no transport process will be detected for this period.

Such processes can only be analyzed if the period with which they are to be expected is known. Then corresponding patterns are looked for in these periods. The knowledge of when mailbox emptying takes place in a node area and of the time window within which the mail is delivered enable the expert system to detect mailbox emptying and mail delivery with a very high detection probability.

This means that the entire logistics chain, including processing times through which a test letter (QTL) has passed, are determined.

This is a decisive advantage which the linkage of tracking systems with the QTL system brings with it. Finally the actual duration of the test run is determined. If the duration of the test run<=the required test run for the type of message monitored, the run type objective is achieved. If the values deviates upward it should be investigated when and where this deviation arose in order to determine the incorrect process and the location at which the error arose.

After the complete actual logistical process sequence for the current measurement has been determined, the expert system can compare this with the generated required runs, in the first iteration a check is made as to whether the nodes of the start and destination of the test runs match the nodes of the start and destination of the required runs. If they do not the entries for start and destination address may be incorrect.

Furthermore a check is to be made as to whether tracking data of a node is possibly missing. If this is not the case the expert system required-actual comparison retrieves the corresponding required runs from the required run generator for the actual start and end nodes.

If a match in the sequence of the nodes was found only the required runs should be considered for which the nodes passed through match the passage of the test. If this is not the case incorrect routing can be assumed.

It is highly probable that the node of which last matched the sequence in the required run is the node where the incorrect routing occurred.

Successive checks are then made as to the extent to which individual transport processes correspond to one other. Provided there is a required run in which no differences have occurred this process is continued and the other required runs are discarded. Should all further processes also a match the required run the test run has executed correctly. Should a deviation have been found, a check is to be made as to whether synchronization occurs again in the subsequent process. If it does, a partial non-relevant deviation can be assumed to have occurred.

If a synchronization is to be achieved by an offset of one or more days, it must be assumed that the test message was delayed in one of the processing stages.

If the transport time for a process was clearly exceeded, congestion or breaks that were too long can be the cause of the delay.

A delayed start of the transport process is highly probably a result of the transshipment time being exceeded or non-adherence to the completion time for the previous processing operation.

In this way the expert system is in a position to automatically detect the time and place where the error arose in the process sequence as well as the process affected by the error. This makes fully-automatic evaluation of QTL test runs possible for the first time.

The procedural sequences are illustrated with reference to the following structure descriptions (FIG. 7-8) with different variants for message identification.

Postal services increasingly use 2D barcodes for franking items of mail. To identify the QTL messages 5 as well as the test run QTL ID numbers, test run ID numbers and further data, such as time specifications are created 1, accepted into the QTL measurement and memory unit 3 of the QTL message 5 and transmitted to a unit 2 for generation of the 2D bar code, which is connected to a barcode printer 4. Subsequently the 2D bar code is printed on the QTL message 5. In parallel to this the test run data, QTL data and time data 1, as well as data 6 for the point of entry and exit into or from the logistics network (e.g. zip codes) and for the selected transport conditions, e.g. on the basis of the type of postal item, are transmitted to a database 10 and an expert system 7 for generation of required transport courses, of which the required run data 9 created with the aid of a set of rules 8 including the QTL and test run identification are stored in the database 10. After the QTL message 5 is entered into the logistics network, i.e. into the incoming node, the surfaces of the message with the printed information are scanned using a scanner 11. Then the 2D bar code is read into the 2D bar code reader 12 and the corresponding data 13 such as QTL and test run ID, time specifications and location including machine id are transmitted to the database 10. Furthermore the destination address is read in an address reader 14 and the sorting code 15 determined, on the basis of which the sorting and further distribution via further sorting centers/nodes not shown in the drawing up to the last sorting center is undertaken. In this node, as well as in the nodes preceding it, the surfaces of the message are also scanned by means of a scanner 16 and the QTL message 5 is identified by means of a 2D bar code reader 17. Subsequently the QTL ID, test run ID and also time specifications, machine code and location of the machine are sent to the database 10 of the system. QTL ID and test run ID enable the data to be appropriately assigned by the database. In the last sorting center the message ID is also read as a bar code 19 and thus the sorting code 20 determined, accordingly the QTL message 5 is then sorted and distributed to the receiver. After the QTL message 5 is delivered the data from the QTL memory 3 is read out and sent to the database 10. Subsequently the data of the possible required transport courses is compared, as described above with the data of the relevant actual transport course by an expert system 22 and any differences in the logistical sequence are detected, and the error which led to these differences identified. Subsequently the results 23 of the error analysis for the relevant test run (QTL ID, test run ID, analysis data, quality codes, error log) are written back into the database 10.

The same method can also be applied in a modified form to alternate bar codes e.g. planet codes etc. Naturally it is also possible to attach separate machine-readable ID codes for identifying the QTL messages.

By expanding the electrical circuit and the firmware or software of known QTL messages (see: EP 0744030 B1, DE 196 19 068 A1) into a combined measurement system with RFID characteristics, it is possible to identify the QTL messages 5 by means of antennas 33, 34, 37 and thereby establish a spatiotemporal relationship.

In the embodiment of the QTL message 5 with an active RFID transponder, the QTL message 5 sends out its data such as QTL ID, RFID transponder ID and test run ID, via a small antenna 33 with its QTL measurement and memory unit 3. This data is received by an antenna 34, 37 in the relevant node and forwarded to an RFID reader 35, 38. This reader adds a time stamp and a location identifier and transmits this data 36, 39 to the database 10.

In the embodiment with a passive RFID transponder the QTL message 5 is embodied as a receiver. A permanent location id, is sent by a transmitter in the node concerned. The QTL measurement and memory unit 3 stores this identifier with the associated time stamp in its measurement data memory. The times of the first and of the last receipt of the same location code are registered. This means that the time spent at a specific location/node (e.g. sorting center) can also be determined.

In a similar way WLAN technology or GSM can also be employed to identify a localize the QTL message.

The required transport courses are generated and the automatic error analysis undertaken in accordance with the previous explanations given.

To Identify messages with the least possible effort and without attaching particular identifiers (specific machine-readable codes) to the messages or providing them with transmit and/or receive devices, a method has been developed for identifying a message on the basis of characteristic features obtained from the image, known as fingerprints (DE 40 00 603 C2). To simplify the application of this identification technique in practice a method has furthermore been described with which the search space for the identification of messages can be clearly restricted (EP 1 222 037 B1).

As presented below, this method will be expanded so that in combination with the application described above, a specific identification of the messages can be dispensed with. (see FIG. 9)

This requires all messages on this path to be able to be uniquely identified if possible.

Before the sending of the QTL message 5 what is known as the fingerprint of the QTL message 5 is defined in the initialization phase.

The fingerprint contains characteristic features which are derived from the image recorded by means the scanner 40 by a fingerprint detection unit 41, on the basis of which the relevant QTL message 5 can be identified in subsequent processing steps. To assign the data determined and to be analyzed in this case too, as already described further data, such as QTL ID, test run ID, time specifications, together with the fingerprints is transmitted to the database 10 and together with the logistics network entry and exit points, type of message, are transmitted to the expert system 7 for a generation of the required transport courses. When a message is recorded on entry into the logistics network/outgoing sorting center, the fingerprint and the sorting information is determined as in initialization by a scanner 42 and a fingerprint recognition unit 43. This data is sent together with time specifications, the information about the sorting center (node) and processing machine as well as if necessary further information about the message, to the central server with the database 10, where, through a comparison of the stored fingerprints restricted by the address specifications with the fingerprint characteristics actually computed for a message, the relevant QTL message 5 is identified. If the similarity is sufficiently great and if other alternatives can be excluded, the relevant message counts as being identified. Then the information stored in a data base 10 can be assigned to this message. In this case a data record is created but with a current time stamp and new sorting information. Furthermore the destination address is read with an address reader 44 and the QTL message 5 transported onwards accordingly. These data records 45, in addition to the database, are made available to the further sorting centers determined in accordance with the transport path in which they are stored in each case in a local database and where a comparison with the actual fingerprints determined there by means of scanner 47 and fingerprint recognition unit 48 and a described identification of a QTL message is undertaken. The current data record 49 of the identified message with new location and time specifications is then transferred to the database. This enables the scope of data traffic with the database 10 to be reduced. On the basis of the unique ID number issued for each QTL message 5 the data records belonging to the individual processing steps can be assigned to one another. For a completely recorded QTL message 5 it can thus be verified when and where and in which distribution and sorting step it was processed.

1. A method for automatically analyzing transport courses in logistics networks using quality test letters (QTL), in which physical characteristics are recorded over time during the transport and subsequently read out and classified in accordance with transport process steps, comprising:
identifying each QTL message in a node, and determining spatiotemporal relations in respect of the nodes passed through,
automatically determining logistical process chain passed through by each message with process elements from the spatiotemporal relations and recorded physical states,
automatically generating all possible required transport courses of each QTL message sent, starting from a respective point of entry and point of exit into or from the logistics network with associated times as well as selected transport conditions from defined transport rules between the nodes of the logistics network and from a description of execution sequences in the nodes and the relationships between the nodes,
performing a comparison between all required transport courses and an actual transport course of each transported QTL message, and determining differences, and
recording the differences between the actual transport course and the required transport course and the required transport course with the closest match for each transported QTL message in a weak point database.

2. (canceled)

3. The method of claim 2, wherein the differences recorded in the weak point database are evaluated statistically.

4. The method of claim 2, wherein the logistics network is divided up into network planes and part networks for each of which the transport rules between the nodes and the description of the execution sequences in the nodes and the relationships between the nodes are defined.

5. The method of claim 2, wherein the differences in respect of the identified part process and/or the deviation type and/or the deviation cause are evaluated.

6. The method of claim 1, wherein, to allow the QTL messages to be identified, these messages are provided with machine-readable identifications.

7. The method of claim 6, wherein, to identify the QTL messages, at least one QTL message identification and a test run identification are incorporated into 2D bar codes for franking further information.

8. The method of claim 1, wherein, to identify the QTL messages, these messages are provided with transponders which will be read out in the node and stored with a time stamp.

9. The method of claim 1, wherein the QTL messages recognize that they have passed through a node on the basis of a stationary identification sent by radio, and this information is stored with a time stamp in the QTL message.

10. The method of claim 1, wherein to identify the QTL message, the characteristic features are determined from its surface with the address specifications and stored together with the destination addresses as well as the further test data in a database, in the required nodes the characteristic features of the message surfaces with the address specifications of the incoming messages are likewise determined in accordance with time and stored in the database and the relevant QTL message is determined by comparing the features detected in the node with the features assigned to the QTL message, in which case a match to the defined extent means that the QTL message is identified.

11. The method of claim 1, wherein to identify the QTL message before its entry into the logistics network, characteristic features are determined from its surface and are stored together with the destination address as well as the further test data in a central database, the data for these features and the further test data are transmitted to the required node and the relevant QTL message is determined by means of a comparison between the transmitted and the detected features, in which case a match to the defined extent means that the QTL message is identified.
